(19) United States
(12) Patent Application Publication
(10) Pub. No.: US 2025/0335270 A1
(43) Pub. Date: Oct. 30, 2025

(54) DYNAMIC NOTIFICATIONS ACROSS ECOSYSTEM

(71) Applicant: Dell Products L.P., Round Rock, TX (US)

(72) Inventors: Vivekanandh Narayanasamy RAJAGOPALAN, Bangalore (IN); Gokul Thiruchengode VAJRAVEL, Bangalore (IN); Vivek Viswanathan IYER, Saint Johns, FL (US)

(73) Assignee: Dell Products L.P., Round Rock, TX (US)

(21) Appl. No.: 18/646,167

(22) Filed: Apr. 25, 2024

(51) Int. Cl. G06F 9/54; G06F 8/65

(52) U.S. Cl. CPC G06F 9/542; G06F 8/65

(57) ABSTRACT

An information handling system may include at least one processor and a memory. The information handling system may be configured to: receive information regarding a notification for a particular user of a plurality of users, wherein each user of the plurality of users is associated with one or more endpoint devices capable of receiving notifications; determine a particular endpoint device, wherein the particular endpoint device is a most recently used one of the one or more endpoint devices associated with the particular user; transmit the notification to the particular endpoint; and in response to a non-acknowledgment of the transmit the notification, notification to a different endpoint device of the one or more endpoint devices associated with the particular user.

### TECHNICAL FIELD

The present disclosure relates in general to information handling systems, and more particularly to dynamic notifications.

### BACKGROUND

As the value and use of information continues to increase, individuals and businesses seek additional ways to process and store information. One option available to users is information handling systems. An information handling system generally processes, compiles, stores, and/or communicates information or data for business, personal, or other purposes thereby allowing users to take advantage of the value of the information. Because technology and information handling needs and requirements vary between different users or applications, information handling systems may also vary regarding what information is handled, how the information is handled, how much information is processed, stored, or communicated, and how quickly and efficiently the information may be processed, stored, or communicated. The variations in information handling systems allow for information handling systems to be general or configured for a specific user or specific use such as financial transaction processing, airline reservations, enterprise data storage, or global communications. In addition, information handling systems may include a variety of hardware and software components that may be configured to process, store, and communicate information and may include one or more computer systems, data storage systems, and networking systems.

Users of information handling systems often have more than one such system. For example, a user might have a desktop at work, a desktop at home, a laptop for travel (which may or may not be connected to a dock), a smartphone, etc.

This can cause issues when a user needs to be notified about something, and particularly when the notification needs to be acknowledged or acted upon in some way. For example, a user might need to receive a notification about an update that will require rebooting a particular information handling system. If that message is routed to a system that is not currently in use, the user might not receive it for some time.

Accordingly, embodiments of this disclosure provide a framework for dynamic notifications across a whole ecosystem of information handling systems.

It should be noted that the discussion of a technique n the Background section of this disclosure does not constitute an admission of prior-art status. No such admissions are made herein, unless clearly and unambiguously identified as such.

### SUMMARY

In accordance with the teachings of the present disclosure, the disadvantages and problems associated with management of notifications may be reduced or eliminated.

In accordance with embodiments of the present disclosure, an information handling system may include at least one processor and a memory. The information handling system may be configured to: receive information regarding a notification for a particular user of a plurality of users, wherein each user of the plurality of users is associated with one or more endpoint devices capable of receiving notifications; determine a particular endpoint device, wherein the particular endpoint device is a most recently used one of the one or more endpoint devices associated with user; transmit the notification to the 15 the particular particular endpoint device; and in response to a non-acknowledgment of notification, the transmit the notification to a different endpoint device of the one or more endpoint devices associated with the particular user.

In accordance with these and other embodiments of the present disclosure, a method may include an information handling system receiving information regarding a notification for a particular user of a plurality of users, wherein each user of the plurality of users is associated with one or more endpoint devices capable of receiving 25 notifications; the information handling system determining a particular endpoint device, wherein the particular endpoint device is a most recently used one of the one or more endpoint devices associated with the particular user; the information handling system transmitting the notification to the particular endpoint device; and in response to a non-acknowledgment of the notification, the information handling system transmitting the notification to a different endpoint device of the one or more endpoint devices associated with the particular user.

In accordance with these and other embodiments of the present disclosure, an article of manufacture may include a non-transitory, computer-readable medium having computer-executable instructions thereon that are executable by a processor of an information handling system for: receiving information regarding a notification for a particular user of a plurality of users, wherein each user of the plurality of users is associated with one or more endpoint devices capable of receiving notifications; determining a particular endpoint device, wherein the particular endpoint device is a most recently used one of the one or more endpoint devices associated with the particular user; transmitting the notification to the particular endpoint device; and in response to a non-acknowledgment of the notification, transmitting the notification to a different endpoint device of the one or more endpoint devices associated with the particular user.

Technical advantages of the present disclosure may be readily apparent to one skilled in the art from the figures, description and claims included herein. The objects and advantages of the embodiments will be realized and achieved at least by the elements, features, and combinations particularly pointed out in the claims.

It is to be understood that both the foregoing general description and the following detailed description are examples and explanatory and are not restrictive of the claims set forth in this disclosure.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a block diagram of an example information handling system, in accordance with embodiments of the present disclosure;

FIG. 2 illustrates an architecture diagram, in accordance with embodiments of the present disclosure; and

FIG. 3 illustrates a sequence diagram of a method, in accordance with embodiments of the present disclosure.

### DETAILED DESCRIPTION

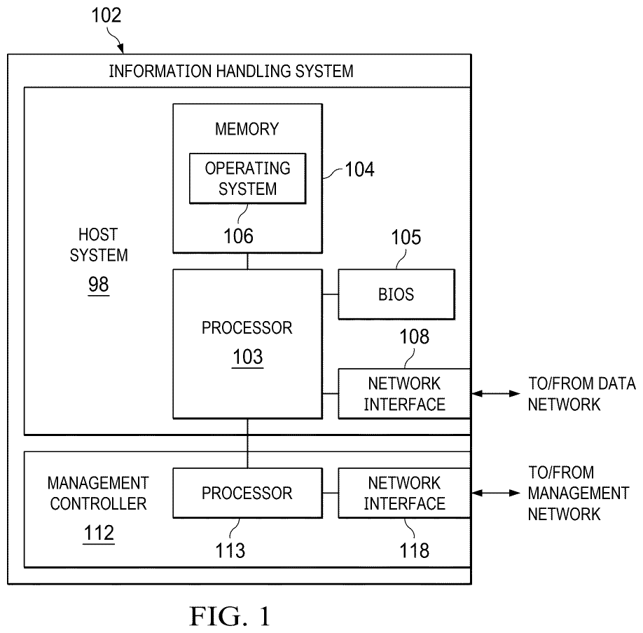

Preferred embodiments and their advantages are best understood by reference to FIGS. 1 through 3, wherein like numbers are used to indicate like and corresponding parts.

For the purposes of this disclosure, the term “information handling system” may include any instrumentality or aggregate of instrumentalities operable to compute, classify, process, transmit, receive, retrieve, originate, switch, store, display, manifest, detect, record, reproduce, handle, or utilize any form of information, intelligence, or data for business, scientific, control, entertainment, or other purposes. For example, an information handling system may be a personal computer, a personal digital assistant (PDA), a consumer electronic device, a network storage device, or any other suitable device and may vary in size, shape, performance, functionality, and price. The information handling system may include memory, one or more processing resources such as a central processing unit (“CPU”) or hardware or software control logic. Additional components of the information handling system may include one or more storage devices, one or more communications ports for communicating with external devices as well as various input/output (“I/O”) devices, such as a keyboard, a mouse, and a video display. The information handling system may also include one or more buses operable to transmit communication between the various hardware components.

For purposes of this disclosure, when two or more elements are referred to as “coupled” to one another, such term indicates that such two or more elements are in electronic communication or mechanical communication, as applicable, whether connected directly or indirectly, with or without intervening elements.

When two or more elements are referred to as “coupleable” to one another, such term indicates that they are capable of being coupled together.

For the purposes of this disclosure, the term “computer-readable medium” (e.g., transitory or non-transitory computer-readable medium) may include any instrumentality or aggregation of instrumentalities that may retain data and/or instructions for a period of time. Computer-readable media may include, without limitation, storage media such as a direct access storage device (e.g., a hard disk drive or floppy disk), a sequential access storage device (e.g., a tape disk drive), compact disk, CD-ROM, DVD, random access memory (RAM), read-only memory (ROM), electrically erasable programmable read-only memory (EEPROM), and/or flash memory; communications media such as wires, optical fibers, microwaves, radio waves, and other electromagnetic and/or optical carriers; and/or any combination of the foregoing.

For the purposes of this disclosure, the term “information handling resource” may broadly refer to any component system, device, or apparatus of an information handling system, including without limitation processors, service processors, basic input/output systems, buses, memories, I/O devices and/or interfaces, storage resources, network interfaces, motherboards, and/or any other components and/or elements of an information handling system.

For the purposes of this disclosure, the term “management controller” may broadly refer to an information handling system that provides management functionality (typically out-of-band management functionality) to one or more other information handling systems. In some embodiments, a management controller may be (or may be an integral part of) a service processor, a baseboard management controller (BMC), a chassis management controller (CMC), or a remote access controller (e.g., a Dell Remote Access Controller (DRAC) or Integrated Dell Remote Access Controller (iDRAC)).

FIG. 1 illustrates a block diagram of an example information handling system 102, in accordance with embodiments of the present disclosure. In some embodiments, information handling system 102 may comprise a server chassis configured to house a plurality f servers or “blades.” In other embodiments, information handling system 102 may comprise a personal computer (e.g., a desktop computer, laptop computer, mobile computer, and/or notebook computer). In yet other embodiments, information handling system 102 may comprise a storage enclosure configured to house a plurality of physical disk drives and/or other computer-readable media for storing data (which may generally be referred to as “physical storage resources”). As shown in FIG. 1, information handling system 102 may comprise a processor 103, a memory 104 communicatively coupled to processor 103, a BIOS 105 (e.g., a UEFI BIOS) communicatively coupled to processor 103, a network interface 108 communicatively coupled to processor 103, and a management controller 112 communicatively coupled to processor 103.

In operation, processor 103, memory 104, BIOS 105, and network interface 108 may comprise at least a portion of a host system 98 of information handling system 102. In addition to the elements explicitly shown and described, information handling system 102 may include one or more other information handling resources.

Processor 103 may include any system, device, or apparatus configured to interpret and/or execute program instructions and/or process data, and may include, without limitation, a microprocessor, microcontroller, digital signal processor (DSP), application specific integrated circuit (ASIC), or any other digital or analog circuitry configured to interpret and/or execute program instructions and/or process data. In some embodiments, processor 103 may interpret and/or execute program instructions and/or process data stored in memory 104 and/or another component of information handling system 102.

Memory 104 may be communicatively coupled to processor 103 and may include any system, device, or apparatus configured to retain program instructions and/or data for a period of time (e.g., computer-readable media). Memory 104 may include RAM, EEPROM, a PCMCIA card, flash memory, magnetic storage, opto-magnetic storage, or any suitable selection and/or array of volatile or non-volatile memory that retains data after power to information handling system 102 is turned off.

As shown in FIG. 1, memory 104 may have stored thereon an operating system 106. Operating system 106 may comprise any program of executable instructions (or aggregation of programs of executable instructions) configured to manage and/or control the allocation and usage of hardware resources such as memory, processor time, disk space, and input and output devices, and provide an interface between such hardware resources and application programs hosted by operating system 106. In addition, operating system 106 may include all or a portion of a network stack for network communication via a network interface (e.g., network interface 108 for communication over a data network). Although operating system 106 is shown in FIG. 1 as stored in memory 104, in some embodiments operating system 106 may be stored in storage media accessible to processor 103, and active portions of operating system 106 may be transferred from such storage media to memory 104 for execution by processor 103.

Network interface 108 may comprise one or more suitable systems, apparatuses, or devices operable to serve as an interface between information handling system 102 and one or more other information handling systems via an in-band network. Network interface 108 may enable information handling system 102 to communicate using any suitable transmission protocol and/or standard. In these and other embodiments, network interface 108 may comprise a network interface card, or “NIC.” In these and other embodiments, network interface 108 may be enabled as a local area network (LAN)-on-motherboard (LOM) card.

Management controller 112 may be configured to provide management functionality for the management of information handling system 102. Such management may be made by management controller 112 even if information handling system 102 and/or host system 98 are powered off or powered to a standby state. Management controller 112 may include a processor 113, memory, and a network interface 118 separate from and physically isolated from network interface 108.

As shown in FIG. 1, processor 113 of management controller 112 may be communicatively coupled to processor 103. Such coupling may be via a Universal Serial Bus (USB), System Management Bus (SMBus), and/or one or more other communications channels.

Network interface 118 may be coupled to a management network, which may be separate from and physically isolated from the data network as shown. Network interface 118 of management controller 112 may comprise any suitable system, apparatus, or device operable to serve as an interface between management controller 112 and one or more other information handling systems via an out-of-band management network. Network interface 118 may enable management controller 112 to communicate using any suitable transmission protocol and/or standard. In these and other embodiments, network interface 118 may comprise a network interface card, or “NIC.” Network interface 118 may be the same type of device as network interface 108, or in other embodiments it may be a device of a different type.

As discussed above, embodiments of this disclosure provide a framework for dynamic notifications across a whole ecosystem of information handling systems 102 that a user might own or have access to. For example, such notifications may relate to installing updates, changing configuration settings, or any other topic.

As more and more services and system intelligence tools are offered through the software as a service (Saas) model, suggestions and problem remediations may be computed both on the local system in offline scenarios and in the cloud in online scenarios. The notifications associated with these activities may include configuration change notifications, software availability, software features, update notifications regarding drivers, firmware, applications, etc. Users generally desire to be informed about such activities.

However, this can give rise to difficulties. For example, an administrator may desire to be notified about any changes in a user's workspace due to offline user actions and/or system auto-remediations. For example, consider a user who has an on-the-box (OTB) service such as a network troubleshooter that has modified the network adapter's MTU size to max jumbo frame size. Although this may help an application function for that user, the administrator needs to be notified about such changes in order to account for them in future support cases or optimizations.

As another example, an end user might desire to be notified about any informational and actionable messages (of various criticality levels) in any active device(s), so that the notifications are not missed. For example, the user's laptop might be connected to multiple monitors, a keyboard, and a mouse via a smart dock. The user puts the laptop into a sleep mode and closes the lid, and the monitor is in standby mode. When an administrator pushes an update for the dock, the user should receive a notification message (e.g., it could be popped up in the monitor via on-screen display text or via a different device).

In general, it is desirable to manage the tracking, delivery, action results, and error handling of messages across different device and OS types. For example, if an administrator pushes a message to a user's workspace, it would be advantageous to be able to see whether the message was delivered to the right device (e.g., the user's active device). If this delivery fails, it should be retried at the user's next available and active device, etc. Overall, the complete status of the message should be available to the administrator from the triggering of the message, any retries, and the eventual delivery status, as well as any action by the user acknowledging or acting on the message. (For purposes of this disclosure, the term “workspace” may refer to a particular information handling system and the ecosystem of devices connected thereto.)

Existing mechanisms to notify and take remedial action based on a notification are not robust enough to handle the permutations inherent in large numbers of workspaces types, device types, Os types, etc. A scalable notification framework is needed for a better user experience.

Embodiments of the present disclosure provide such a framework, which may be implemented via several different components. Some of the components operate in the cloud. Others operate on the user's endpoint device (referred to as “on-the-box” or “OTB” services) and may be implemented separately for each type of endpoint device and each OS that may be installed thereon.

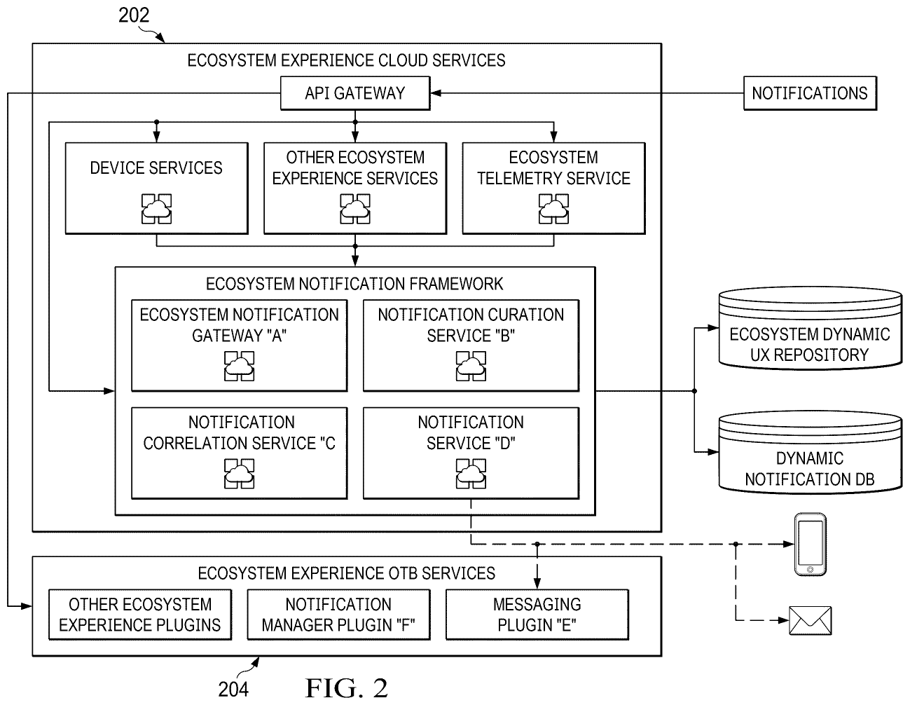

FIG. 2 provides an example architecture diagram for a notification framework, according to some embodiments. Within ecosystem experience cloud services 202, several different components are implemented.

For example, an ecosystem notification (ESN) gateway “A” may provide an API that receives notifications from any source. Any and all cloud services that need to post notifications to a user and/or device may post the notification to this service. If the notification is targeted for a particular user, this service may work with ecosystem experience services to identify the active workspace and the associated devices for the targeted user.

A notification curation service “B” may receive the message and the targeted user from ESN gateway “A.” This service may determine the user's active device and work with an ecosystem dynamic user experience repository to fetch the UX/UI elements that best fit the message and the device.

A notification correlation service “C” may look for redundant or related messages (if any) that are targeted for the user and/or device. If any subsequent messages are unneeded, this service may suppress them to prevent the user receiving a burst of related messages.

A notification service “D” may receive the notification message and target device details. Based on the target device, the notification service “D” selects the best notification channel and sends the notification.

At the user's endpoint device(s), ecosystem experience OTB services 204 includes several components as shown for managing notifications. For example, the message from notification service “D” is received and executed by messaging plugin “E”.

A notification manager “F” then receives and processes the messages and delivers them to the end user in the targeted channel type (e.g., system tray notifications, application popups, SMS messages, etc.) and tracks the actions associated with the notifications and sends the results back to the ecosystem experience cloud services 202.

In some embodiments, notification manager “F” may also perform additional message correlation and deduplication, similar to notification correlation service “C” discussed above. For example, notification manager “F” may also detect correlations between local notifications and cloud-originated notifications, suppressing those that are determined to be redundant regardless of their origination point.

These OTB components may also handle notifications flowing in the other direction, from the user's endpoint device to the cloud. For example, if the user makes a configuration change on endpoint device that an administrator needs to know about, the other ecosystem experience plugins may transmit a notification via the API gateway of ecosystem experience cloud services 202. That message may then be processed as above, but with the notification eventually making its way to the administrator's active endpoint device.

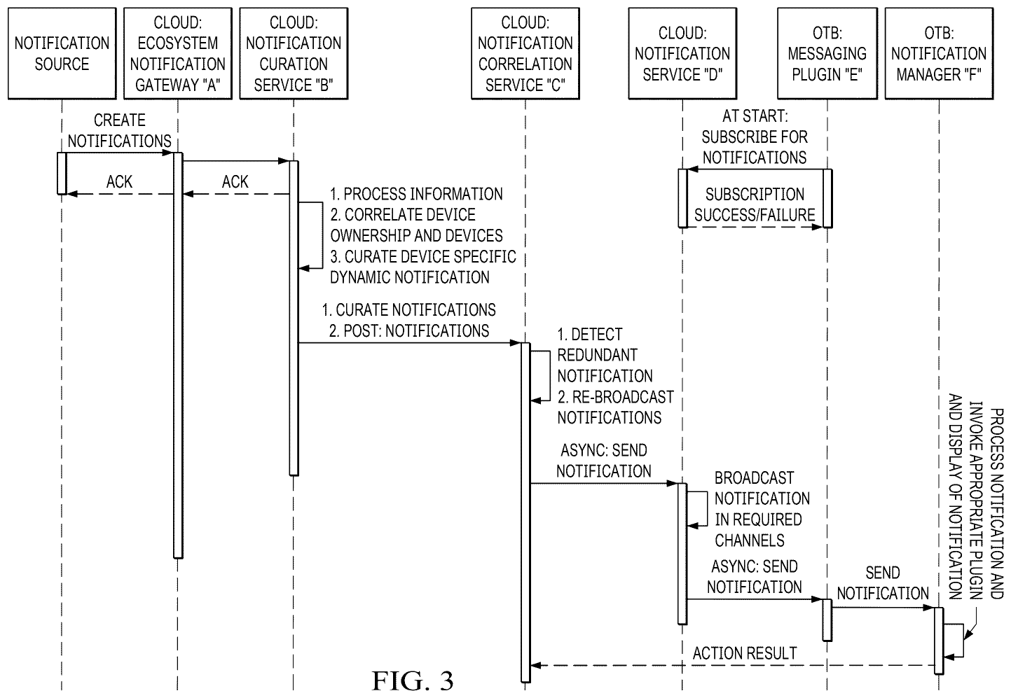

Turning now to FIG. 3, an example sequence diagram is shown illustrating the flow of messages associated with a notification. The flow of messages and acknowledgments is largely in accordance with the discussion of FIG. 2 above, but with some additional details. For example, the sequence diagram of FIG. 3 shows how messaging plugin “E” at the endpoint device can subscribe to notifications from the cloud notification service “D.” In some embodiments, messaging plugin “E” may selectively subscribe to only certain types of desired notifications, etc.

One of ordinary skill in the art with the benefit of this disclosure will understand that the preferred initialization point for the method depicted in FIG. 3 and the order of the steps comprising the method may depend on the implementation chosen. In these and other embodiments, these method may be implemented as hardware, firmware, software, applications, functions, libraries, or other instructions. Further, although FIG. 3 discloses a particular number of steps to be taken with respect to the disclosed method, the method may be executed with greater or fewer steps than depicted. The method may be implemented using any of the various components disclosed herein (such as the components of FIG. 1), and/or any other system operable to implement the method.

Thus embodiments of this disclosure may provide many benefits. For example, a user may be associated with multiple workspaces (e.g., simultaneously or in series). Whenever any notification source (e.g., a cloud-based service) needs to communicate with a user, the notification source need not be concerned with the details of message delivery. The notification source can transmit the notification to a single API, and the framework described herein may handle the delivery and all tasks related thereto.

Further, if a notification fails to be delivered (e.g., if an acknowledgement is not received within a given timeframe), then the framework may detect the failure and the notification to a different endpoint by resend determining the next-best active workspace for the user, etc.

This disclosure encompasses all changes, substitutions, variations, alterations, and modifications to the exemplary embodiments herein that a person having ordinary skill in the art would comprehend. Similarly, where appropriate, the appended claims encompass all changes, substitutions, variations, alterations, and modifications to the exemplary embodiments herein that a person having ordinary skill in the art would comprehend. Moreover, reference in the appended claims to an apparatus or system or a component of an apparatus or system being adapted to, arranged to, capable of, configured to, enabled to, operable to, or operative to perform a particular function encompasses that apparatus, system, or component, whether or not it or that particular function is activated, turned on, or unlocked, as long as that apparatus, system, or component is so adapted, arranged, capable, configured, enabled, operable, or operative.

Further, reciting in the appended claims that structure is “configured to” or “operable to” perform one or more tasks is expressly intended not to invoke 35 U.S.C. § 112(f) for that claim element. Accordingly, none of the claims in this application as filed are intended to be interpreted as having means-plus-function elements. Should Applicant wish to invoke § 112(f) during prosecution, Applicant will recite claim elements using the “means for [performing a function]” construct.

All examples and conditional language recited herein are intended for pedagogical objects to aid the reader in understanding the invention and the concepts contributed by the inventor to furthering the art, and are construed as being without limitation to such specifically recited examples and conditions. Although embodiments of the present inventions have been described in detail, it should be understood that various changes, substitutions, and alterations could be made hereto without departing from the spirit and scope of the disclosure.

What is claimed is:

1. An information handling system comprising:
at least one processor; and
a memory;
wherein the information handling system is configured to:
receive information regarding a notification for a particular user of a plurality of users, wherein each user of the plurality of users is associated with one or more endpoint devices capable of receiving notifications;
determine a particular endpoint device, wherein the particular endpoint device is a most recently used one of the one or more endpoint devices associated with the particular user;
transmit the notification to the particular endpoint device; and
in response to a non-acknowledgment of the notification, transmit the notification to a different endpoint device of the one or more endpoint devices associated with the particular user.

2. The information handling system of claim 1, wherein the notification relates to installation of an update.

3. The information handling system of claim 1, wherein the one or more endpoint devices includes at least one laptop and at least one smartphone.

4. The information handling system of claim 1, further configured to:
receive information regarding a plurality of notifications for the particular user;
determine that one of the plurality of notifications is duplicative of another one of the plurality of notifications; and
suppress the one of the plurality of notifications from being transmitted.

5. The information handling system of claim 1, further configured to:
prior to receiving the information regarding the notification, receive a subscription request from the particular user.

6. The information handling system of claim 1, wherein transmitting the notification to the particular endpoint device comprises communicating with an on-the-box service executing at the particular endpoint device.

7. A method comprising:
an information handling system receiving information regarding a notification for a particular user of a plurality of users, wherein each user of the plurality of users is associated with one or more endpoint devices capable of receiving notifications;
the information handling system determining a particular endpoint device, wherein the particular endpoint device is a most recently used one of the one or more endpoint devices associated with the particular user;
the information handling system transmitting the notification to the particular endpoint device; and
in response to a non-acknowledgment of the notification, the information handling system transmitting the notification to a different endpoint device of the one or more endpoint devices associated with the particular user.

8. The method of claim 7, wherein the notification relates to installation of an update.

9. The method of claim 7, wherein the one or more endpoint devices includes at least one laptop and at least one smartphone.

10. The method of claim 7, further comprising:
the information handling system receiving information regarding a plurality of notifications for the particular user;
the information handling system determining that one of the plurality of notifications is duplicative of another one of the plurality of notifications; and
the information handling system suppressing the one of the plurality of notifications from being transmitted.

11. The method of claim 7, further comprising:
prior to receiving the information regarding the notification, the information handling system receiving a subscription request from the particular user.

12. The method of claim 7, wherein transmitting the notification to the particular endpoint device comprises communicating with an on-the-box service executing at the particular endpoint device.

13. An article of manufacture comprising a non-transitory, computer-readable medium having computer-executable instructions thereon that are executable by a processor of an information handling system for:
receiving information regarding a notification for a particular user of a plurality of users, wherein each user of the plurality of users is associated with one or more endpoint devices capable of receiving notifications;
determining a particular endpoint device, wherein the particular endpoint device is a most recently used one of the one or more endpoint devices associated with the particular user;
transmitting the notification to the particular endpoint device; and
in response to a non-acknowledgment of the notification, transmitting the notification to a different endpoint device of the one or more endpoint devices associated with the particular user.

14. The article of claim 13, wherein the notification relates to installation of an update.

15. The article of claim 13, wherein the one or more endpoint devices includes at least one laptop and at least one smartphone.

16. The article of claim 13, wherein the instructions are further executable for:
receiving information regarding a plurality of notifications for the particular user;
determining that one of the plurality of notifications is duplicative of another one of the plurality of notifications; and
suppressing the one of the plurality of notifications from being transmitted.

17. The article of claim 13, wherein the instructions are further executable for:
prior to receiving the information regarding the notification, receiving a subscription request from the particular user.

18. The article of claim 13, wherein transmitting the notification to the particular endpoint device comprises communicating with an on-the-box service executing at the particular endpoint device.
